(19) United States
(12) Patent Application Publication
(10) Pub. No.: US 2026/0326415 A1
(43) Pub. Date: Oct. 22, 2026

(54) Direct Lamination of a Melamine Layer to a Magnesium Oxide Core

(71) Applicant: Columbia Insurance Company, Omaha, NE (US)

(72) Inventors: Anthony Drevet, Chattanooga, TN (US); Christopher Karl Andrews, Dalton, GA (US)

(73) Assignee: Columbia Insurance Company, Omaha, NE (US)

(21) Appl. No.: 19/563,588

(22) Filed: Mar. 11, 2026

Related U.S. Application Data
(63) Continuation of application No. 17/449,669, filed on Oct. 1, 2021, now Pat. No. 12,703,171.
Application No. 17/449,669 is a continuation-in-part of application No. 16/580,668, filed on Sep. 24, 2019, now Pat. No. 12,109,790.
(60) Provisional application No. 62/735,607, filed on Sep. 24, 2018.
(60) Provisional application No. 63/198,198, filed on Oct. 2, 2020.

(51) Int. Cl. B32B 7/12; B32B 29/06; B32B 37/12

(52) U.S. Cl. CPC B32B 7/12; B32B 29/06; B32B 37/1284; B32B 2037/1215; B32B 2250/03; B32B 2250/40; B32B 2260/028; B32B 2260/046; B32B 2311/00; B32B 2471/00

(57) ABSTRACT

Embodiments of the present disclosure include a floor panel having a melamine-impregnated layer laminated on a layered magnesium-oxide core. The layered magnesium-oxide core can comprise one or more adhesion-promoting layers including an adhesion-promoting agent, such as cellulosic fibers, polymers, or adhesive.

### CROSS-REFERENCE TO RELATED APPLICATIONS

This application titled “Direct Lamination of a Melamine Layer to a Magnesium Oxide Core” is a continuation-in-part application claiming the benefit to U.S. patent application Ser. No. 16/580,668 filed Sep. 24, 2019 titled “Composite Panels Having a Melamine Impregnated Protective Layer,” which claims the benefit of Provisional Application No. 62/735,607 filed Sep. 24, 2018 and titled “Solid Polymer-Based or Mineral-Based Core Flooring and Wall Panel Having Melamine Impregnated Paper Wear layer,” which is hereby incorporated by reference in its entirety as if set forth below. This application also claims priority to Provisional Application No. 63/198,198 filed Oct. 2, 2020, titled “Direct Lamination of a Melamine Layer to a Magnesium Oxide Core.”

### BACKGROUND

There is a growing desire in the flooring industry to create laminate flooring products with a magnesium-oxide core that are scratch-resistant, water-resistant, and may be affixed to each other in a manner that avoids movement underfoot. The adhesive and wear-resistant properties of melamine, melamine formaldehyde, or melamine urea formaldehyde treated papers are an attractive option for flooring manufactured using lamination processes.

Magnesium-oxide cores cannot hold a melamine-impregnated layer directly laminated thereon. When subject to conventional lamination processes that involve applying heat and pressure, the magnesium-oxide cores release moisture, which interferes with the adhesion properties of the melamine-impregnated layer. This causes delamination of the melamine layer during use, which is highly undesirable.

Embodiments of the present disclosure are directed to these and other considerations.

### SUMMARY OF THE INVENTION

Embodiments of the present disclosure are directed to improved floor panels and methods for providing such improved floor panels. Specifically, the improved floor panels include one or more melamine-impregnated layers that have been directly laminated onto a magnesium-oxide core, the magnesium-oxide core having been manufactured using a wet-process method. Such direct lamination can be achieved by providing a layered magnesium-oxide core in which layers or portions of the layered magnesium-oxide core (specifically those that directly contact the melamine-impregnated layer) include an adhesion-promoting agent. The adhesion-promoting agent can be cellulosic fibers (e.g., wood, bamboo, rice straw fibers), a polymer (e.g., PET, polyurethane, and polyester), or an adhesive.

Due to the inclusion of adhesion-promoting layers in the core, the floor panels exhibit markedly improved adhesion properties between the melamine-impregnated layer and magnesium-oxide core, thus preventing delamination during use. Specifically, the adhesion-promoting layers act as a buffer to prevent moisture from being released from the core and allow for quick adhesion of the melamine-impregnated layer to the core upon application of heat and pressure.

Such floor panels can further include any known locking mechanism to allow for interconnection with other floor panels to create a floating floor.

### BRIEF DESCRIPTION OF THE DRAWINGS

FIG. 1 is a vertical cross-section of a floor panel, according to one embodiment of the present disclosure.

FIG. 2 is a vertical cross-section of a floor panel additionally including a locking mechanism and backing layer, according to one embodiment of the present disclosure.

### DETAILED DESCRIPTION

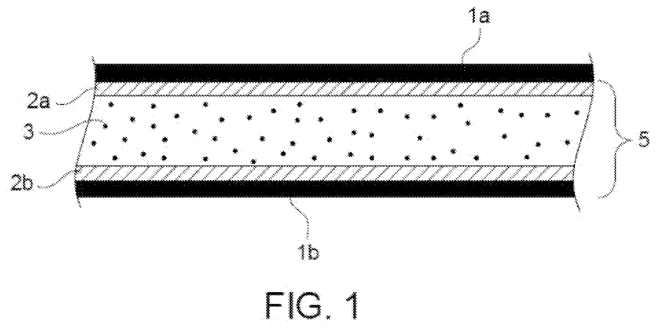

FIG. 1 is a vertical cross-section of a floor panel, according to one embodiment of the present disclosure. The floor panel comprises a top melamine-impregnated layer la and may further comprise an optional bottom melamine-impregnated layer 1b bonded to the top and bottom surfaces of a layered core 5. The layered core 5 comprises at least a top adhesion-promoting layer 2a and a magnesium-oxide layer 3. If a bottom melamine-impregnated layer 1b is desired, a bottom adhesion-promoting layer 2b is also provided on the core 5. A layered core 5 having both top and bottom melamine-impregnated layers 1a, 1b is preferred, but not required.

The top and bottom melamine-impregnated layers 1a, 1b can be applied to the layered core 5 using a lamination process (e.g., hot-press lamination) such that the top melamine-impregnated layer la can be adhered to the top adhesion-promoting layer 2a and the bottom melamine-impregnated layer 1b can be adhered to the bottom adhesion-promoting layer 2b.

The melamine-impregnated layers 1a, 1b can be substantially scratch-resistant to accommodate the wear-and-tear of normal use. The melamine-impregnated layers 1a, 1b can be any one of melamine formaldehyde (MF) or melamine urea formaldehyde (MUF) treated papers, films, or other decorative layers. In some embodiments, the melamine-impregnated layers 1a, 1b can comprise a decorative pattern applied to the paper, film, or other decorative layer. For instance, the decorative pattern can be applied using a digital-printing process. In one or more example embodiments, the melamine-impregnated layer 1a (top melamine layer) can be a melamine-impregnated paper décor layer which acts as a decorative layer, a wear layer, and/or a scratch resistant layer; and the melamine-impregnated layer 1b (bottom balancing layer) can be a melamine-impregnated paper layer (may not include the decorative image).

In some embodiments, the melamine-impregnated layers 1a, 1b can comprise texturing or embossing to provide a natural appearance to the floor panel. For instance, texturing or embossing can be applied using a continuous press, a batch press, or similar lamination process.

In some embodiments, the melamine-impregnated layers 1a, 1b can also include an additive to promote bonding with the layered core 5.

The adhesion-promoting layers 2a, 2b of the layered core 5 can comprise magnesium oxide and an adhesion-promoting agent. In some embodiments, the adhesion-promoting agent can comprise at least one of cellulosic fibers (e.g., wood, bamboo, rice straw fibers), polymers (e.g., PET, polyurethane, and polyester), or an adhesive to promote adhesion between the layered core 5 and the melamine-impregnated layers 1a, 1b when laminated together. In some embodiments, the adhesion-promoting layers 2a, 2b can have substantially the same composition as the magnesium-oxide layer 3 apart from the addition of the adhesion-promoting agent.

In some example embodiments, the density of the layered core 5 may be uniform across the different layers (2a, 3, 2b). However, in other example embodiments, the layered core 5 may have different densities across the various layers. For example, the densities of one or both of the adhesion-promoting layers 2a, 2b may be different (higher or lower) from the magnesium-oxide layer 3. Further, in some example embodiments, the top adhesion-promoting layer 2a may have a print-adhesion promoting agent that configures the surface of the layered core 5 for receiving direct digital printing thereon and promotes adhesion of the digitally printed ink to the layered core 5 (e.g., exhibiting a pull value of at least 7). In said example embodiments, where an image is directly digitally printed on the layered core 5, the melamine-impregnated layer may be transparent and may be configured to enhance the clarity of the image on the layered core 5 (or otherwise prevent a blurred look).

In some embodiments, the adhesion-promoting layers 2a, 2b can have from approximately 15% by weight to approximately 50% by weight of adhesion-promoting agent.

In some embodiments, the adhesion-promoting layers 2a, 2b can further comprise a filler to fill any pits or voids in the adhesion-promoting layers 2a, 2b. The filler can be any conventional filler material, such as wood putty or polymers.

While the embodiment of the layered core 5 of the floor panel illustrated in FIG. 1, includes a top and a bottom adhesion-promoting layer 2a, 2b, it is understood that in some embodiments, the floor panel may have only one adhesion-promoting layer. For instance, in an embodiment where the floor panel only has a top melamine-impregnated layer 1a, the layered core 5 may only include a top adhesion-promoting layer 2a.

The layered core 5 can also comprise a magnesium-oxide layer 3 disposed below the top adhesion-promoting layer 2a. In some embodiments, the magnesium-oxide layer 3 can comprise magnesium oxide and magnesium chloride. In some embodiments, the magnesium-oxide layer 3 can additionally comprise a sulfate. The magnesium-oxide layer 3 can be substantially free of the adhesion-promoting agent. In some example embodiments, the magnesium oxide layer 3 and/or the adhesion-promoting layers (2a, 2b) may include at least 30% ash content.

In some embodiments, the layered core 5 can be formed using a wet process. During the wet process, the two or more adhesion-promoting layers 2a, 2b can be applied to the magnesium-oxide layer 3 to form the layered core 5. Wet process formation of a magnesium-oxide core includes mixing the components of the core as a slurry and then curing the slurry over time. When forming the layered core using a wet process, the various layers would be applied sequentially. In some example embodiments, the layered core 5 can be formed using a dry process (e.g., a non-slurry process where ingredients are mixed in dry form and compressed to form the core) without departing from a broader scope of the present disclosure.

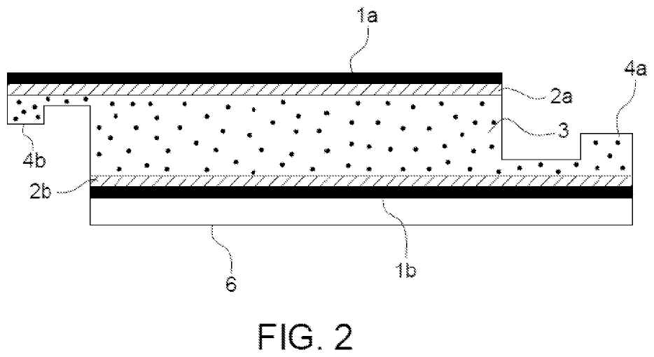

FIG. 2 is a vertical cross-section of a floor panel, according to one embodiment of the present disclosure. The floor panel of FIG. 2 is similar to that illustrated in FIG. 1 except that it includes a locking mechanism profile 4a, 4b and an optional backing layer 6.

The locking mechanism profile 4a, 4b can allow for several floor panels to be linked together to provide a floating floor. The layered core 5 can have an internal bond strength to accommodate milling or cutting a locking mechanism profile 4a, 4b within the layered core 5. To allow for milling or cutting the locking mechanism profile 4a, 4b, the internal bond strength of the layered core 5 can be at least 1.5 N/mm². In some embodiment, the internal bond strength can be achieved by including a fiberglass mesh within the layered core 5. The locking mechanism profile 4a, 4b can be any locking mechanism known in the art.

In some embodiments, the floor panel can comprise an optional backing layer 6. The backing layer 6 can be applied to improve the soundproofing or comfort of the floor underfoot.

The floor panel can be cut in various dimensions and created in various thicknesses depending on product design needs. In an exemplary embodiment, the total thickness of the floor panel can be from approximately 4 mm to approximately 6 mm. In some embodiments, the total thickness of the floor panel can be approximately 3 mm. In some embodiments, the thickness of the floor panel can be from approximately 3 mm to approximately 22 mm.

Embodiments of the present disclosure can also comprise a method for manufacturing a floor panel. The method can comprise forming a layered core using a wet process, comprising creating a first layer comprising magnesium oxide and an adhesion-promoting additive, applying a second layer on top of the first layer, the second layer being substantially free of the adhesion-promoting additive, and applying a third layer on top of the second layer, the third layer comprising magnesium oxide and an adhesion-promoting additive. The method of making can further comprise laminating a melamine-impregnated layer to a top surface of the layered core using a hot-press process.

In some embodiments, the laminating step can also comprise laminating a melamine-impregnated layer to a bottom surface of the layered core using a hot-press process.

In some embodiments, prior to the laminating step, the layered core can be sanded.

In some embodiments, the method of making can further comprise cutting a locking mechanism profile on both ends of the floor panel.

In some embodiments, the method of making can further comprise attaching a backing layer to the floor panel.

1-8. (canceled)

9. A surface covering panel comprising:
a melamine-impregnated layer; and
a layered, mineral-based core disposed below the melamine-impregnated layer, the layered, mineral-based core comprising:
a first layer directly bonded to the melamine-impregnated layer and comprising a mineral component and at least 15% by weight of an agent configured to promote adhesion between the first layer and the melamine-impregnated layer, the agent comprising cellulosic fibers; and
a second layer disposed directly below the first layer and being substantially free from the agent, wherein a density of the second layer is greater than or equal to a density of the first layer.

10. The surface covering panel of claim 9, wherein the melamine-impregnated layer comprises one or more papers, films or decorative layers treated with one of melamine formaldehyde or melamine urea formaldehyde.

11. The surface covering panel of claim 10, wherein the melamine-impregnated layer comprises a decorative pattern.

12. The surface covering panel of claim 9, wherein the melamine-impregnated layer comprises one of a wear layer or a scratch resistant layer.

13. The panel of claim 9, wherein the melamine-impregnated layer further comprises an additive to promote bonding to the layered mineral-based core.

14. The panel of claim 9, wherein the first layer of the mineral-based core further comprises a filler.

15. The panel of claim 9, wherein the second layer of the mineral-based core comprises at least 30% ash.

16. The panel of claim 9, wherein the layered, mineral-based core further comprises a third layer disposed directly below the second layer.

17. The panel of claim 16, further comprising a second melamine-impregnated layer directly bonded to the third layer, and wherein the third layer comprises a mineral component and an agent configured to promote adhesion to the second melamine-impregnated layer.

18. The panel of claim 9, further comprising a backing layer disposed below the layered mineral-based core.

19. A panel comprising:
a melamine-impregnated layer; and
a layered, mineral-based core disposed below the melamine-impregnated layer, the layered core comprising:
a first layer directly bonded to the melamine-impregnated layer and comprising a mineral component and an agent configured to promote adhesion between the first layer and the melamine-impregnated layer; and
a second layer disposed directly below the first layer and being substantially free from the agent, wherein a density of the second layer is greater than or equal to a density of the first layer.

20. The panel of claim 19, wherein the melamine-impregnated layer comprises one or more papers, films or decorative layers treated with melamine formaldehyde or melamine urea formaldehyde.

21. The panel of claim 20, wherein the melamine-impregnated layer comprises a decorative pattern.

22. The panel of claim 19, wherein the melamine-impregnated layer is transparent.

23. The panel of claim 22, wherein the first layer further comprises:
an ink layer that is disposed and is digitally printed directly thereon, and
a print-adhesion promoting agent to promote adhesion between the first layer and the ink layer that is digitally printed thereon,
wherein the melamine-impregnated layer is directly bonded to the first layer having the ink layer.

24. The panel of claim 19, wherein the agent is selected from a group consisting of cellulosic fibers, polymers, and adhesive.

25. The panel of claim 19, wherein the melamine-impregnated layer further comprises an additive to promote bonding to the layered, mineral-based core.

26. The panel of claim 24, wherein the polymer is selected from the group consisting of PET, polyurethane, and polyester.

27. The panel of claim 19, wherein the first layer of the layered, mineral-based core further comprises a filler.

28. The panel of claim 19, wherein the second layer of the layered, mineral-based core comprises at least 30% ash.

29. The panel of claim 19, wherein the layered, mineral-based core further comprises a third layer disposed directly below the second layer, wherein the third layer comprises a mineral component and an agent configured to promote adhesion to a second melamine-impregnated layer.
